(19) United States
(12) Patent Application Publication
(10) Pub. No.: US 2004/0105079 A1
(43) Pub. Date: Jun. 3, 2004

(54) Image formation apparatus

(76) Inventors: Takeshi Yamakawa, Ohta-ku (JP); Rumiko Ono, Ohta-ku (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/643,993

(22) Filed: Aug. 20, 2003

(30) Foreign Application Priority Data
Aug. 20, 2002 (JP) 2002-239381

(51) Int. Cl. G03B 27/00

(52) U.S. Cl. 355/18

(57) ABSTRACT

In an image formation apparatus, a light emitted from a light source is deflected towards a condensing lens, the condensing lens condenses the light and focuses the light on an image carrier. An optical housing houses the condensing lens. The condensing lens is fixed to a fixing member and the fixing member is fixed to the optical housing. The condensing lens may be fixed to the fixing member with adhesive. The fixing member may be fixed to the optical housing with adhesive, screws, or snap fastners.

### BACKGROUND OF THE INVENTION

1) Field of the Invention

The present invention relates to an image formation apparatus in which a condensing lens of a writing unit is fixed to an optical housing.

2) Description of the Related Art

FIG. 8 is a cross-section of a configuration of a conventional copying machine, FIG. 9 is a cross-section of a scanner (i.e., image reading apparatus) of the copying machine, and FIG. 10 is a perspective view of a writing unit (i.e., laser beam scanner) of the copying machine.

The copying machine has a scanner 11, a printer 12, and a document feeder 13. The printer includes a writing unit 70A. The document feeder 13 automatically conveys one sheet of document set on this document feeder onto a contact glass 14. Moreover, the document feeder 13 discharges the document from the contact glass 14 to the outside once the copying is over.

The scanner 11 has a first carriage A, and a second carriage B, as shown in FIG. 9. A light source including an illumination lamp 15 and a reflection mirror 16, and a first mirror 17 are provided on the first carriage A. A second mirror 18 and a third mirror 19 are provided on the second carriage B.

The document is scanned as follows. The first carriage A moves forward at a constant speed, and the second carriage B moves forward at a speed of one half of that of the first carriage A. The illumination lamp 15 and the reflection mirror 16 illuminate the document. A lens 21 forms an image on a charge-coupled device (hereinafter, “CCD”) sensor 22 via the first mirror 17, the second mirror 18, the third mirror 19, and a color filter 20. The CCD sensor 22 converts the optical image of the document into analog electric signals, and outputs the analog image signal. Finally, the first carriage A and the second carriage B return to their home positions respectively.

An analog-to-digital converter converts the analog image signal from the CCD sensor 22 into a digital image signal. An image processing unit 23 carries out various kinds of image processing, such as a binarization, a multiple value processing, multiplication, edition. If a three-line CCD having a line of CCD each for a red (R) filter, a green (G) filter, and a blue (B) filter is provided, then a color document can be read.

In the printer 12, a driving section (not shown) rotates a photosensitive drum (i.e., image carrier) 25 during the copying operation. A charging unit 26 uniformly charges the photosensitive drum 25. The digital image signal processed by the image processing unit 23 is sent to a driving unit not shown. The writing unit 70A exposes the image according to the digital image signal, and forms an electrostatic latent image on the photosensitive drum 25. A developing unit 28 develops the electrostatic latent image on the photosensitive drum 25, into a toner image.

One paper feeding unit selected from among paper feeding units 33 to 35 feeds a transcription paper (not shown) to a resist roller 36. The transcription paper is sent from the resist roller 36 in timing with the image on the photosensitive drum 25. A transfer apparatus 30 transfers the toner image formed on the photosensitive drum 25, onto the transcription paper. A separating unit 31 separates the transcription paper from the photosensitive drum 25, and conveys the transcription paper, and a conveying unit 37 conveys this transcription paper. A fixing unit 38 fixes the transferred image, and discharges the fixed image to a tray 39. A cleaning unit 32 cleans the photosensitive drum 25 after the transcription paper is separated, and removes residual toner.

As shown in FIG. 10, in the writing unit 70A, a collimating lens (not shown) transforms a laser beam emitted from a semiconductor laser into a parallel light flux. This parallel light is passed through an aperture (not shown) of specific shape to shape the light flux into a certain shape. A cylindrical lens 40a focuses this light flux into a sub-scanning direction, and makes the light flux fall onto a polygon mirror 42. The polygon mirror 42 has an accurate polygon. A polygon motor 41 rotates the polygon mirror 42 in one direction at a constant speed. The rotation speed of the polygon mirror 42 is determined in accordance with the rotation speed of the photosensitive drum 25, the writing density of the writing unit 70A, and the number of planes of the polygon mirror 42.

The polygon mirror 42 deflects the light flux so that the light flux falls on an fθ lens 43. The fθ lens 43 transforms the laser beam into a shape such that a scanning light of a steady angular speed from the polygon mirror 42 scans the photosensitive drum 25 at an equal speed. The laser beam from the fθ lens 43 forms an image on the photosensitive drum 25 via a reflection mirror 45 and a dust-proof glass 46. The fθ lens 43 also has an optical face tangle error correction function. A synchronization detection mirror 47 reflects the laser beam that passes through the fθ lens 43, at the outside of the image area, and leads the laser beam to a synchronization detection sensor 48. The synchronization detection sensor 48 outputs a detection result, thereby to obtain a synchronization signal that becomes a reference of a head of a main scanning direction.

A suction fan 24 is disposed at a lower portion of one end of the scanner 11. A blower 90 is disposed near the developing unit 28 within the printer 12. External air suctioned with the suction fan 24 via an external cover flows toward the image processing unit 23 within the scanner 11, and it is discharged to the outside of the copying machine. This air cools the optical system (i.e., optical parts) within the scanner 11. The external air suctioned with the blower 90 via the external cover cools around the photosensitive drum 25, and thereafter cools the polygon motor 42 and the optical system within the writing unit 70A.

Various configurations have been proposed to fix the condensing lens (hereinafter, “lens”) of the scanning and image formation optical system, in other words, the scanning lens, to an optical housing. For example, when the lens is positioned or fixed in a corresponding portion of the lens within the image area, this lens is fitted to the optical housing via an adhesive layer, when the lens is directly brought into contact with the housing.

Although the optical housing is substantially airtight, the temperature inside the optical housing or of the optical housing changes depending on, for example, the duration for which the image formation apparatus is used, or even due to a change in the environmental temperature.

If the temperature inside or of the optical housing changes, the lens, because it is fitted to the optical housing directly or via an adhesive, deforms. Since the fθ lens is long and made of plastic, it deforms considerably. If the lens deforms, its optical characteristics change. If the optical characteristics of the lens change, the image quality in a sub-scanning direction degrades. This problem becomes particularly prominent if the condensing lens is made by molding or the optical housing is made of a material having low specific heat.

### SUMMARY OF THE INVENTION

It is an object of the present invention to solve at least the problems in the conventional technology.

In an image formation apparatus according to the present invention, a light emitted from a light source is deflected towards a condensing lens, the condensing lens condenses the light and focuses the light on an image carrier. An optical housing houses the condensing lens. The condensing lens is fixed to a fixing member and the fixing member is fixed to the optical housing. The condensing lens may be fixed to the fixing member with adhesive. The fixing member may be fixed to the optical housing with adhesive, screws, or snap fastners.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a top plan view of a configuration for fixing a condensing lens in an optical housing according to a first embodiment of the present invention;

FIG. 2 is a cross-section of the configuration shown in FIG. 1;

FIG. 3 is a top plan view of a configuration for fixing a condensing lens in an optical housing according to a second embodiment of the present invention;

FIG. 4 is a cross-section of the configuration in FIG. 3 cut along a line A-A;

FIG. 5 is a cross-section of a configuration for fixing a condensing lens in an optical housing according to a third embodiment of the present invention;

FIG. 6 is a top plan view of a configuration for fixing a condensing lens in an optical housing according to a fourth embodiment of the present invention;

FIG. 7 is a cross-section of the configuration shown in FIG. 6;

FIG. 8 is a cross-section of a configuration of a conventional copying machine;

FIG. 9 is a cross-section of a scanner of the conventional copying machine; and

FIG. 10 is a perspective view of a writing unit of the conventional copying machine.

### DETAILED DESCRIPTION

Exemplary embodiments of the configuration for fixing a lens according to the present invention will be explained with reference to the accompanying drawings.

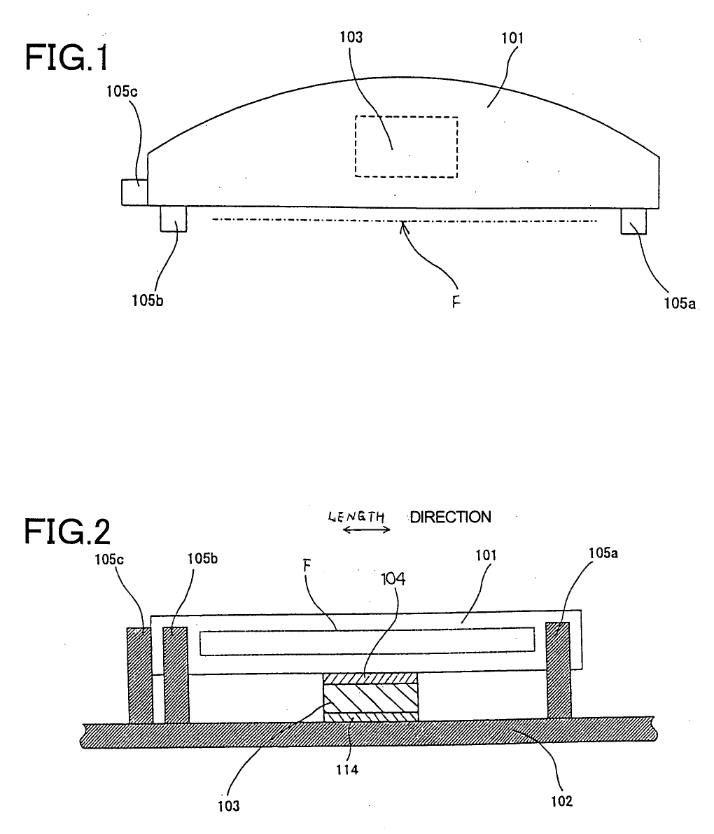

FIG. 1 is a top plan view of a configuration for fixing a condensing lens (i.e., scanning lens) according to a first embodiment of the present invention. FIG. 2 is a cross-section of the configuration shown in FIG. 1. Elongated bosses 105a, 105b, and 105c project from a surface of an optical housing 102. The bosses 105a, 105b, and 105c are provided at positions that are outside of an image formation area F of the condensing lens 101. A fixing member 103 is fixed, to the surface of the optical housing 102, between the condensing lens and the optical housing 102, with an adhesive 114. The condensing lens 101 is fixed, to the surface of the fixing member 103, with an adhesive 104. The adhesives 104 and 114 may be an ultraviolet cure adhesive or a two-sided tape. A surface, of the condensing lens 101, that is perpendicular to the length direction of the condensing lens 101, is made to abut against the boss 105a. A surface, of the condensing lens 101, that is parallel to the length direction of the condensing lens 101, is made to abut against the bosses 105b and 105c. As a result, the condensing lens 101 is secured firmly. In other words, the boss 105c restricts the movement of the condensing lens 101 in the length direction, and the bosses 105a and 105b restrict the movement of the condensing lens 101 in the direction (hereinafter, “width direction”) that is parallel to the length direction.

It may be noticed that, the other end or surface in the length direction, and the other end or surface in width direction, of the condensing lens 101 are free. When the condensing lens 101 deforms due to changes in the environmental temperature, the condensing lens 101 expands or contracts in the direction in which it is free, and the position of the condensing lens 101 does not change. As a result, even if the condensing lens 101 or the fixing member 103 made by molding acrylic resin or polycarbonate resin is used, the image quality does not degrade. Moreover, even the optical housing 102 may be made of an aluminum die-cast product, which has low specific heat.

According to the first embodiment, the condensing lens 101 is fixed to the optical housing via the adhesives 104, 114, and the fixing member 103. The fixing member 103 is made of material having low heat conductivity. Therefore, the fixing member 103 does not conduct heat to the condensing lens 101 from the optical housing 102. Therefore, the image quality does not degrade even if the temperature inside or of the optical housing 102 changes.

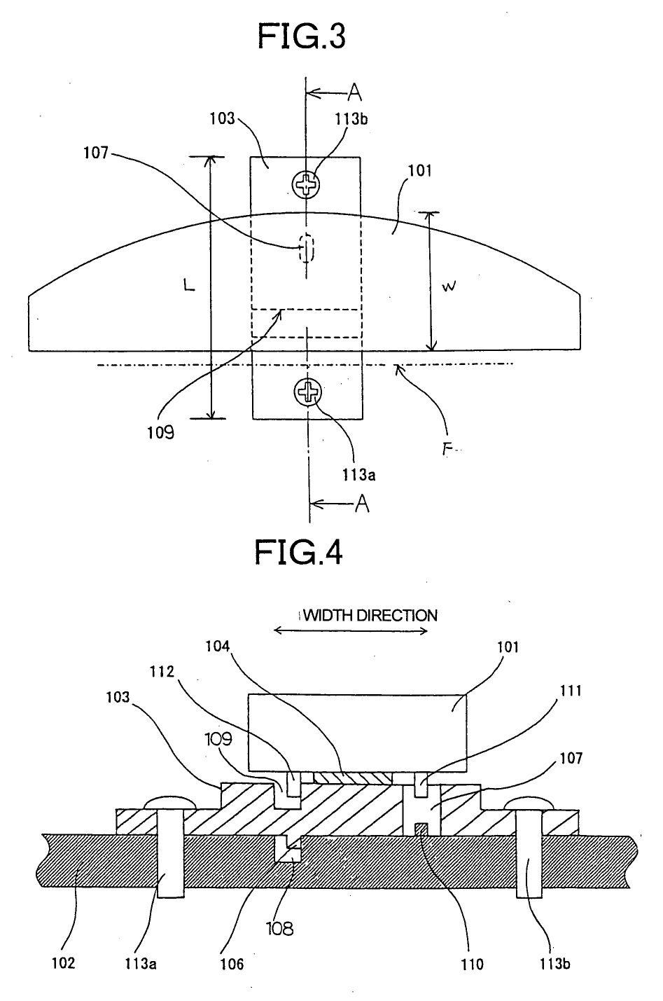

FIG. 3 is a top plan view of a configuration for fixing a condensing lens according to a second embodiment of the present invention. FIG. 4 is a cross-section of the configuration along a line A-A. The fixing member 103 is rectangular. The length L of the fixing member 103 is more than the width W in the widest portion of the condensing lens 101. This fixing member 103 is provided below the widest portion of the condensing lens 101 to be parallel to the width direction of the condensing lens 101.

On the lower surface of the lens 101, a first projection 111 is provided to position the long side of the lens, and a second projection 112 is provided to position the short side of the lens respectively. A positioning projection (i.e., positioning pin) 110 and a first reference groove 108 are provided on the upper surface of the housing 102 respectively. A through-hole (i.e., long hole) 107 is formed in the fixing member 103 along its longitudinal direction. A second reference groove 109 is formed on the upper surface of the fixing member 103 along its width direction. A projection 106 is provided on the lower surface of the fixing member 103.

An ultraviolet cure adhesive 104 is coated onto a predetermined portion of the upper surface of the fixing member 103. The first projection 111 provided on the lens 101 is brought into contact with an upper portion of a side surface of the long hole 107 of the fixing member 103. The second projection 112 is brought into contact with the second reference groove 109 of the fixing member 103. With this arrangement, the lens 101 is positioned on the fixing member 103. Ultraviolet rays are irradiated onto the fixing member 103 from above the lens 101, thereby to fix the lens 101 to the fixing member 103 with the adhesive 104. The projection 106 of the fixing member 103 is inserted into the first reference groove 108 of the housing 102, and is brought into contact with the side surface of this groove. The lower portion of the side surface of the long hole 107 of the fixing member 103 is brought into contact with the positioning projection 110 of the housing 102. With this arrangement, the fixing member 103 is positioned on the housing 102. The fixing member 103 is fixed to the housing 102 with screws 113a and 113b. The first projection 111 is a member to position the long side of the lens 101, and the second projection 112 is a member to position the short side of the lens 101. The projection 106 is a member to position the long side of the fixing member 103, and the positioning projection 110 is a member to position the short side of the fixing member 103. The projections 106 and 112 extend to the longitudinal direction.

According to the second embodiment, the condensing lens 101, the fixing member 103, and the housing 102 can be mutually positioned easily and at high precision. The fixing member 103 is made of material having low heat conductivity. Thus, since the fixing member 103 does not conduct heat to the condensing lens 101 from the optical housing 102, the image quality does not degrade even if the temperature inside or of the optical housing 102 changes.

Moreover, in the conventional configuration, the fixing member is directly fixed to the optical housing with an adhesive, which makes mounting and dismounting of the fixing member cumbersome. On the other hand, in the second embodiment, the fixing member 103 is fixed to the optical housing 102 with the screws. As a result, the fixing member 103 can be easily mounted to and dismounted from the optical housing 102 by tightening or loosing the screws. The fixing member 103 and the optical housing can be even be recycled.

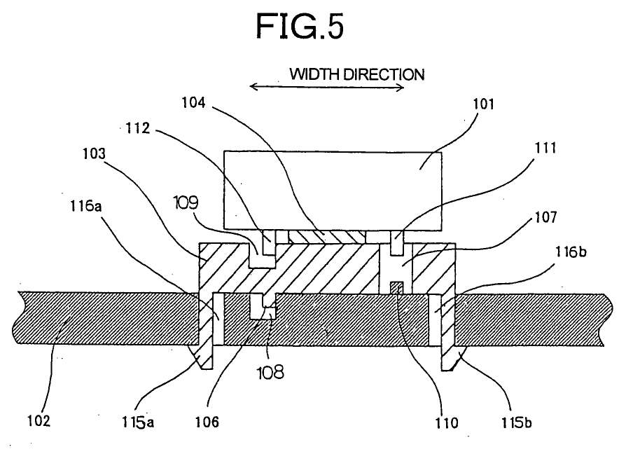

FIG. 5 is a cross-section of a configuration for fixing a condensing lens according to a third embodiment of the present invention. FIG. 5 illustrates a same view as FIG. 4. In the configuration shown in FIG. 4, the fixing member 103 is fixed to the optical housing 102 with the screws 113a and 113b. On the other hand, in the configuration shown in FIG. 5, the fixing member 103 has engagement members, that is, snap fasteners 115a and 115b, formed integrally as a plastic member. This fixing member 103 is snapped to the optical housing 102 with the snap fasteners. Rest of the configuration is similar to that shown in FIG. 4.

Specifically, on the lower surface of the lens 101, the first projection 111 is provided to position the long side of the lens, and the second projection 112 is provided to position the short side of the lens respectively. The positioning projection (i.e., positioning pin) 110 and the first reference groove 108 are provided on the upper surface of the housing 102 respectively. Through-holes 116a and 116b are formed in the housing 102 to pass from the upper surface to the lower surface of the housing 102. The long hole 107 is formed in the fixing member 103 to pass from the upper surface to the lower surface of the fixing member 103, along the longitudinal direction of the fixing member 103. The second reference groove 109 is formed on the upper surface of the fixing member 103. The projection 106 is provided on the lower surface of the fixing member 103. Snap fasteners 115a and 115b are provided at both ends of the short side of the fixing member 103, to extend downward from the lower surface of the fixing member 103.

The ultraviolet cure adhesive 104 is coated onto a predetermined portion of the upper surface of the fixing member 103. The first projection 111 provided on the lens 101 is brought into contact with the side surface of the long hole 107. The second projection 112 is brought into contact with the side surface of the second reference groove 109. With this arrangement, the lens 101 is positioned on the fixing member 103, thereby to fix the lens 101 to the fixing member 103 with the adhesive 104. The projection 106 of the fixing member 103 is inserted into the first reference groove 108, and is brought into contact with the side surface of this groove. The side surface of the long hole 107 of the fixing member 103 is brought into contact with the positioning projection 110 of the housing 102. The snap fasteners 115a and 115b are pushed into the through-holes 116a and 116b, thereby to snap the fixing member 103 to the housing 102. The first projection 111 is a member to position the long side of the lens 101, and the second projection 112 is a member to position the short side of the lens 101. The projection 106 is a member to position the long side of the fixing member 103, and the positioning projection 110 is a member to position the short side of the fixing member 103. The projections 106 and 112 extend to the longitudinal direction.

According to the third embodiment, the condensing lens 101, the fixing member 103, and the housing 102 can be mutually positioned easily and at high precision. The fixing member 103 is made of material having low heat conductivity. Thus, since the fixing member 103 does not conduct heat to the condensing lens 101 from the optical housing 102, the image quality does not degrade even if the temperature inside or of the optical housing 102 changes.

Moreover, in the conventional configuration, the fixing member is directly fixed to the optical housing with an adhesive, which makes mounting and dismounting of the fixing member cumbersome. On the other hand, in the second embodiment, the fixing member 103 is fixed to the optical housing 102 with the snap fasteners. Therefore, the lens having the fixing member 103 can be easily mounted to and dismounted from the housing 102. As a result, the fixing member 103 can be easily mounted to and dismounted from the optical housing 102. The fixing member 103 and the optical housing can be even be recycled. Moreover, since the screws are not required, the number of parts, in other words, the cost is reduced.

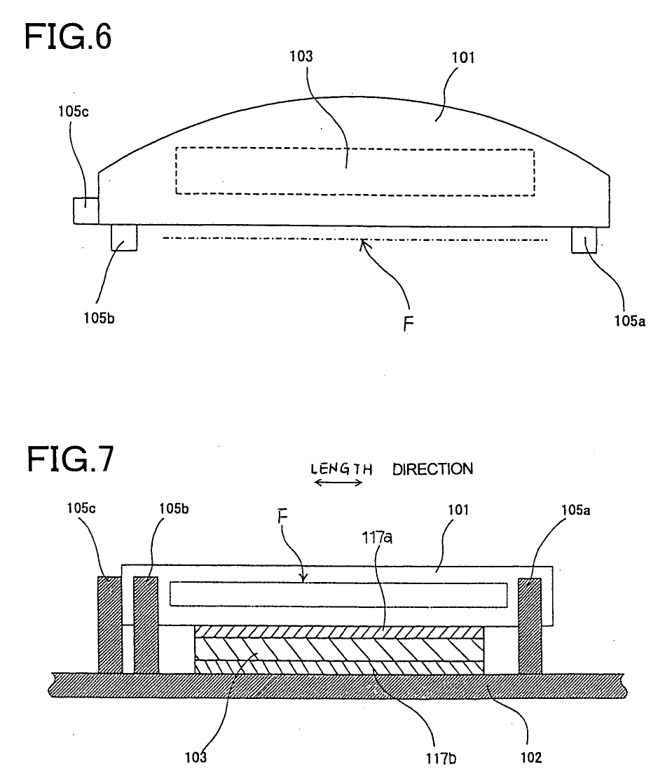

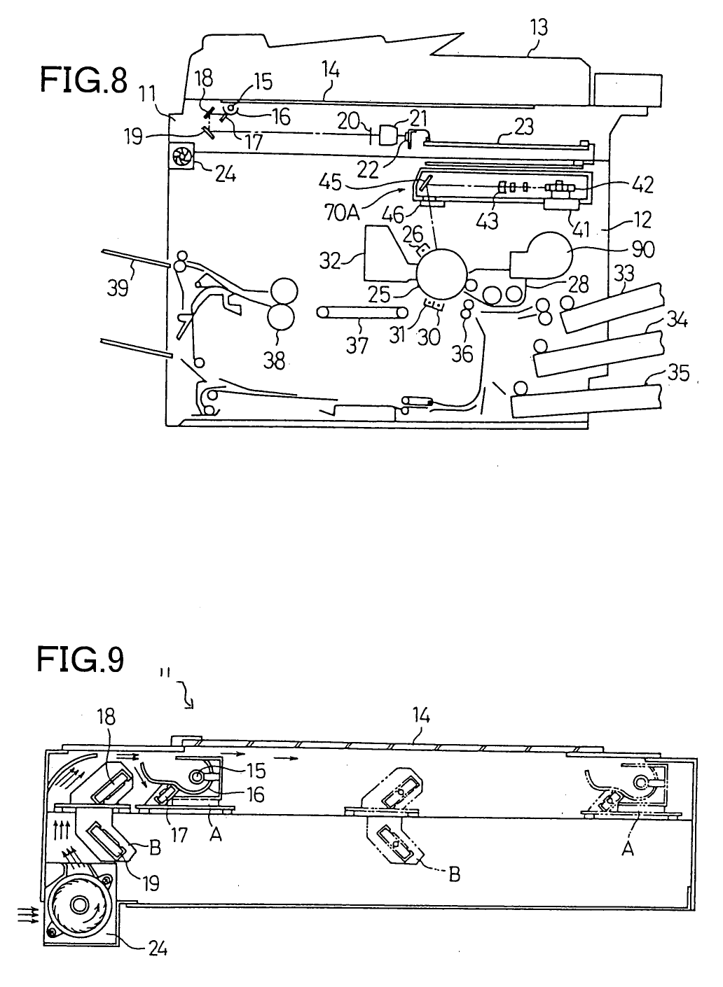

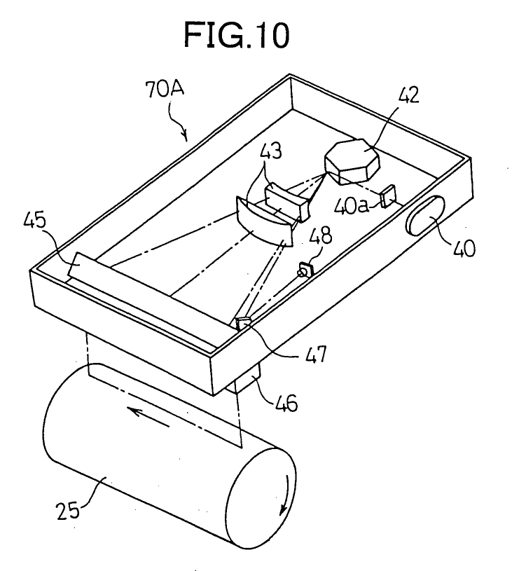

FIG. 6 is a top plan view of a configuration for fixing a condensing lens according to a fourth embodiment of the present invention. FIG. 7 is a cross-section of the configuration shown in FIG. 6. A glass molded product or a plastic molded product having an ultraviolet ray transmittance equal to or more than 50 percent is used for the fixing member 103. Ultraviolet cure adhesives 117a and 117b are coated onto the upper and lower sides of the fixing member 103, and the fixing member 103 is mounted on a predetermined portion of the bottom surface of the housing 102. The lens 101 is mounted on the fixing member 103, and is positioned there with the bosses 105a to 105c in a similar manner to that according to the first embodiment.

Ultraviolet rays are irradiated to the ultraviolet cure adhesives 117a and 117b from above the lens to cure these adhesives. Accordingly, both the lens 101 and the fixing member 103 are fixed to the housing 102 at the same time. The fixing member 103 having the ultraviolet ray transmittance equal to or more that 50 percent is used in the present embodiment. This is for the purpose of making the ultraviolet rays having transmitted through the lens 101 and the adhesive 117a transmit through the fixing member 103 at this high transmittance, thereby to cure the adhesive 117a and 117b at the same time.

In the configuration of the first embodiment shown in FIG. 2, it is also preferable that the fixing member 103 having the ultraviolet ray transmittance equal to or more that 50 percent is also used to fix the fixing member 103 to the housing 102 with the ultraviolet cure adhesive 114. Specifically, the ultraviolet cure adhesives 104 and 114 are coated onto the upper and lower surfaces of the glass molded fixing member, and this fixing member is mounted on the bottom surface of the housing 102. The condensing lens 101 is mounted on the fixing member 103. One end of the long side of the lens is brought into contact with the boss 105c, and one end of the short side (i.e. width) is brought into contact with the bosses 105a and 105b respectively, thereby to position the lens. Thereafter, ultraviolet rays are irradiated onto the fixing member from above the lens, thereby to fix the lens to the fixing member and fix the fixing member to the housing at the same time.

Thus, according to the configuration for fixing the condensing lens of the present invention, the fixing member is made of material having low heat conductivity so that it does not conduct heat to the condensing lens from the optical housing. As a result, since the condensing lens does not deform much, the image quality does not degrade even if the temperature inside or of the optical housing changes.

The fixing member may be fixed to the optical housing by an adhesive, screws, or the snap fasteners. When the fixing member is fixed by screws or snap fasteners, the fixing member can be mounting on or dismounting from the optical housing easily.

The present document incorporates by reference the entire contents of Japanese priority document, 2002-239381 filed in Japan on Aug. 20, 2002.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An image formation apparatus, in which a light emitted from a light source is deflected towards a condensing lens, the condensing lens condenses the light and focuses the light on an image carrier, comprising:
an optical housing that houses the condensing lens;
a fixing member that is fixed to the optical housing, wherein the condensing lens is fixed to the fixing member.

2. The image formation apparatus according to claim 1, wherein
a coefficient of thermal conductivity of the fixing member is lower than a coefficient of thermal conductivity of the optical housing.

3. The image formation apparatus according to claim 1, wherein the condensing lens and the fixing member include positioning units, wherein the positioning units of the condensing lens and the fixing member engaged with each other to thereby to fix the condensing lens to the fixing member.

4. The image formation apparatus according to claim 1, wherein the fixing member and the optical housing include positioning units, wherein the positioning units of the fixing member and the optical housing engaged with each other to thereby to fix the condensing lens to the fixing member.

5. The image formation apparatus according to claim 1, wherein
the fixing member is formed by molding glass and has an ultraviolet ray transmittance equal to or more that 50, and
the fixing member is fixed to the optical housing with an ultraviolet cure adhesive.

6. The image formation apparatus according to claim 1, wherein
the fixing member is formed by molding plastic and has an ultraviolet ray transmittance equal to or more that 50, and
the fixing member is fixed to the optical housing with an ultraviolet cure adhesive.

7. The image formation apparatus according to claim 5, wherein
the condensing lens is fixed to the fixing member with an ultraviolet cure adhesive.

8. The image formation apparatus according to claim 6, wherein
the condensing lens is fixed to the fixing member with an ultraviolet cure adhesive.

9. The image formation apparatus according to claim 1, wherein
a length of the fixing member is equal to or longer than one third of a length of the condensing lens, and the condensing lens is fixed to the fixing member such that the length of the fixing member is parallel to the length of the condensing lens.

10. The image formation apparatus according to claim 1, wherein
a mechanical strength of the fixing member is higher than a mechanical strength of the condensing lens.

11. The image formation apparatus according to claim 1, wherein the fixing member and the optical housing includes holes so that the fixing member and the optical housing are fixed using screws.

12. The image formation apparatus according to claim 1, wherein
the fixing member includes a snap fastener made of plastic, the optical housing includes holes to engage the snap fastener.
